(19) United States
(12) Patent Application Publication
(10) Pub. No.: US 2022/0142183 A1
(43) Pub. Date: May 12, 2022

(54) doughnuts (donuts)

(71) Applicant: David I Grazette, Brooklyn, NY (US)

(72) Inventor: David I Grazette, Brooklyn, NY (US)

(21) Appl. No.: 16/949,629

(22) Filed: Nov. 9, 2020

(51) Int. Cl. A21D 13/60; A21D 13/066; A21D 13/043; A21D 13/047

(52) U.S. Cl. CPC A21D 13/60; A21D 13/047; A21D 13/043; A21D 13/066

(57) ABSTRACT

Human made. Fried on the Moon? Grown on Mars? Delivered on Mercury? Invented on Earth. Doughnuts donuts. doughnuts (donuts). The doughnut (donut), at the core, of this conjunction, unity, in the middle, doughnuts (donuts), created the same; rings. One ring, made, with intention, before each doughnut (donut) rises and fries in junction to and fro flour and sugar, oats and spaces. doughnuts (donuts).

In a pitcher, soak three quarter cup of rolled oats for 24 hours. Drain oats, combine with one and a half cups of water and blend in blender until smooth. Strain and transfer to refrigerator. This is used as oat milk.

In a separate pitcher, completely soak one cup of oats for 24 hours. Drain water from oats and slowly add water while blending oats until smooth. Add two tablespoons of Apple Cider Vinegar and lemon juice and mix. Add one quarter cup water and allow to sit in room temperature for 3 hours before transferring to refrigerator. This is used as sour oats.

In a large bowl, mix thoroughly, three hundred and fifty grams of potato starch, two hundred grams of teff flour, four hundred grams of millet flour, five hundred grams of brown rice flour, three hundred grams of tapioca starch, one hundred and fifty grams of coRn starch, two teaspoons of xanthan gum. This is used as all purpose flour. Allow flour to set for at least twelve hours.

In a large bowl, thoroughly mix two hundred and eighty three grams of white rice flour, one hundred and seventeen grams of sweet rice flour, three hundred grams of tapioca flour, one hundred and fifty grams of coRn starch, one hundred grams of sorghum flour and fifty grams of potato starch. This is used as pastry flour. Allow pastry flour to sit for twelve hours.

In large bowl, thoroughly mix ten ounces of all purpose flour, six ounces of pastry flour, five ounces of granulated sugar, one teaspoon of kosher salt, one teaspoon of baking powder, a half teaspoon of baking soda, one tablespoon of vanilla extract, one and a half tablespoons of psyllium husk.

In a large bowl, thoroughly mix six ounces of cashew milk and one teaspoon of vanilla.

Sprinkle a pinch of all purpose flour on a smooth, flat surface and roll out dough using a rolling pin and all purpose flour until dough is of about one and a half inches. Using a three inch circle cookie cutter, cut circles into flat dough form. Separate newly cut dough pieces, and make a, much smaller, circular incision to the dough and separate. Separate newly formed rings and keep on sheet with sprinkling of all purpose flour.

Place each ring-shaped raw doughnut (donut) and fry in a pot of coRn oil at three hundred degrees Fahrenheit, in a temperature-controlled environment of about sixty eight to seventy seven degrees at sea level, for two minutes on each side.

Allow each to cool, on a grated sheet, for fifteen minutes. doughnuts (donuts).

### BRIEF DESCRIPTION OF DRAWING

FIG. 1 is a bird's eye drawing of the ringed doughnut (donut). The rings crusted and cooked surface can be seen by the circular shading around the doughnut (donut).

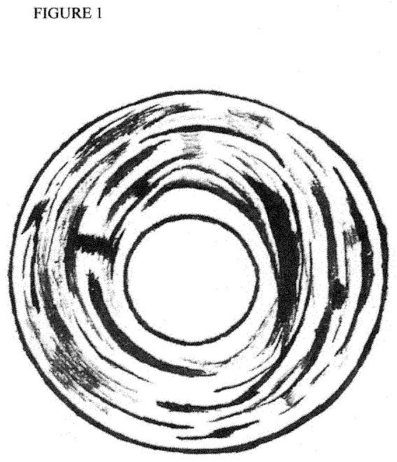

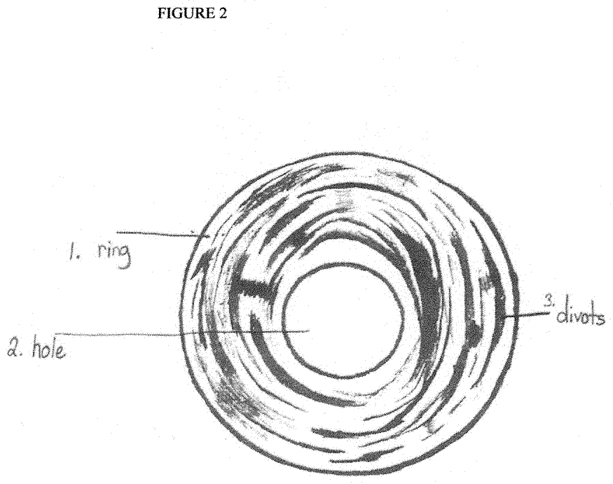

1. doughnuts (donuts)
A breakfast desert made with Gluten-free flour mix;
potato starch, teff flour, millet flour, brown rice, tapioca starch, coRn starch, white rice flour, sweet rice flour, tapioca flour, sorghum flour.

2. doughnuts (donuts)
A breakfast desert made free and absent of lactose, dairy;
Oat foundation/Oat based.

3. doughnuts (donuts)
A breakfast desert shaped, then fried, as a ring; by humans.
